(19) United States
(12) Patent Application Publication
(10) Pub. No.: US 2019/0084819 A1
(43) Pub. Date: Mar. 21, 2019

(54) TWIST OFF BOTTLE CAP REMOVER FOR SMALL BOTTLES

(71) Applicant: ROY MCDANIEL -- MCDANIEL, NORTH RICHLAND HILLS, TX (US)

(72) Inventor: ROY MCDANIEL -- MCDANIEL, NORTH RICHLAND HILLS, TX (US)

(21) Appl. No.: 15/924,936

(22) Filed: Mar. 19, 2018

(51) Int. Cl. B67B 7/18

(52) U.S. Cl. CPC B67B 7/18

(57) ABSTRACT

One embodiment of a one piece thin flat material for removing small sized screw off bottle caps of varying sizes ⅜ inch to 1¼ inches (9.525 mm to 31.750 mm). A “V” shaped aperture communicates the cap with the gripping facets in the “V” to secure and hold the cap for a leveraged counterclockwise twisting motion to remove the cap. The opening accommodates various diameters of crown bottle caps and small twist off tops. The shape of the hand held apparatus enables the user to firmly hold it and readily twist off the bottle cap. Additional contemplated embodiments include opening pull tabs on cans and containers, puncturing liquid cartons for pouring the contents and tearing open plastic bags.

### CROSS-REFERENCE TO RELATED APPLICATIONS

The following is a tabulation of some prior art that presently appears relevant:

### U. S. Patents

U.S. Pat. No. 5,154,101 Oct. 13, 1992 by Dalton H. Wolford, Elinor B. Woldford was for a V-shaped combination jar or bottle cap remover and bag opener. (It related to a larger kitchen tool mounted under a kitchen cabinet.)

U.S. Pat. No. 7,267,031 B1 Sep. 11, 2007 by Joh Burton: Andrew Burton, a bottle cap remover utilizing a pair of axially nested socket sections of different diameters. (Small sized caps and long neck caps such as fingernail polish cannot be addressed by this unit.)

U.S. Pat. No. 8,720,714,B2 May 13, 1914 by Jerome Romero is a combined beverage container opener and cover that has a cup-like guide member that receives the bottle cap. (The cup-like member is restricted to larger caps and defined cap size instead of a larger range of variable sized caps.)

U.S. Pat. No. 6,666,110 Dec. 23, 2003 by Fred A. Buettner, an apparatus for twisting off crown bottle caps by means of a form-fitting cap for twisting off caps. (Device is for larger caps and it's a dedicated specific cap size instead of variable sized caps).

U.S. Pat. No. DES.352,878 Nov. 29, 1994 by Kerry W. Penrose, an ornamental eagle using its wing spread to encompass a bottle cap. (Capable of fixed sized bottle caps, not for variable sizes, or small sizes.)

U.S. Pat. No. 4,455,894 Jan. 26, 1984 by Richard K. Roberts, a hand held opening apparatus with a centrally located socket to fit over a crown cap for removal, a wedged surface for a ring pull tab of a can, and a blade mounted for opening plastic bags. (Telescoped sockets have designated limited dimeter sizes and do not address the small variable sizes of bottle caps.)

### FEDERALLY SPONSORED RESEARCH

N/A

### SEQUENCE LISTING

N/A

### BACKGROUND OF THE INVENTION

Many years ago bottle capping was developed for sealing bottle openings. Later, in 1858 the first patent on twist cap technology for jars was by John Landis Mason, yes the zinc twist cap was for Mason Jars. In 1892 the popular “Crown Cap” for bottles was patented in the U. S. by William Painter. It is a metal cap with a corrugated flange pressed around the lip of a bottle. Crown Caps have to be pried off with hand held or mounted openers. In 1960 due to dwindling supplies of cork and less expensive materials, the new twist off cap for bottles was pressed around screw threads. The popularized screw-off caps could be twisted off by hand instead of pried off. Now, every day millions of twist-off caps are removed from glass and plastic bottles of various diameter openings by applying manual twisting force to the screw-top bottle cap.

Devices exist for removing twist-off caps. Most utilize inserting a “cap” or socket on top of the bottle cap to twist it off, or “compression” type instruments for predetermined size openings. These devices are size or diameter specific and adaptive to a limited variety of bottle cap sizes and materials.

Other existing available openers include partially engaging or telescoping fully around the bottle cap of larger bottles, jars and containers to twist the cap off. They are developed and address the high volume demand for larger caps but are too large for small units. Their larger orifice openings are not effective for smaller sized bottles. The small containers are overlooked or disregarded in the shadows of the larger units.

Industries serving the public find it necessary to improvise on the job to open containers with twist off caps. Airline flight attendants open miniature liquor bottle caps and medium sized wine bottles (splits) with rubber pads or dampened paper towels. They use keys to open ring tab-top cans, and writing pens to open the plastic bags of catering ice. Nail salons use pliers to open new bottles and previously opened bottles that become dry sealed, often breaking the plastic caps. Nurses wrestle with small sealed medicine bottles. The spice extract bottles in restaurant or household kitchens are too small for conventional twist-off cap openers. Pliers open industrial and home workshop metal and plastic containers having small openings with twist off caps.

Frequently the cap is so tightly secured or sealed on the container that it is difficult to loosen and unscrew it. Even a person of ordinary strength may have difficulty removing the cap without the use of pliers or other tools. Bottles that have been re-capped after use (i.e., fingernail polish, spices, liquid medications, honey dispensers) can be challenging to reopen.

Injuries result in the large volume of bottles and cans opened daily. On airlines, in bars or restaurants, medical facilities, in salons and industrial locations injuries result in broken and damaged fingernails, finger blisters, sprains and other physical injuries.

The elderly, handicapped, and health impaired with arthritis, broken hand, wrist, or arm can struggle to sufficiently grasp tightly and twist the container cap for opening. The elderly population in the United States continues to grow so there is an increasing need for assistance. Assistance includes but is not limited to aid in the basic task of opening screw-on small bottle caps, tab containers, or plastic bags in everyday tasks without pain or discomfort.

The existing large hand held devices can be awkward to handle in order to execute opening the containers. Coordination to grasp, hold and operate can be too challenging. Mounted stationary units can be difficult to access and use, in addition to the difficulty installing them.

A need exists for a handy, highly portable method to grasp and provide leverage to twist open small sized twist-off caps. The ability for cap removal with minimum effort, without pain or discomfort, eliminate physical damage to fingers, hands, wrists, and is readily adaptable to varying sizes of screw off container caps.

### SUMMARY

The embodiment of my bottle cap remover has advantages for gripping and opening miniature, small, and medium twist off caps. Caps of varying diameters and extended elongated high designs atop the caps can be opened. Businesses and home environments can benefit the usefulness it provides. Caps are not damaged and can be reused. They can be sealed tight by inverting and twisting the embodiment on the cap in a clockwise direction.

### DESCRIPTION OF THE DRAWINGS

FIG. 1 is the perspective top elevation view. Actual scale to show the small and condensed real dimensions and size.

FIG. 2 is the side elevation of FIG. 1. Actual size scale to show the thin thickness.

FIG. 3 is the 3-D version of FIGS. 1 and 2. Slightly enlarged scale.

### DRAWINGS

### Reference Numerals

9 “V” construction profile, opening tapers ⅜ inch to 1¼ inches (9.525 mm to 31.750 mm)

| | | | |
|---|---|---|---|
| 10 | slanted faceted teeth | 11 | eyelet hole |
| 12 | beveled tips | 13 | vertex teeth |

### DETAILED DESCRIPTION

### First Embodiment

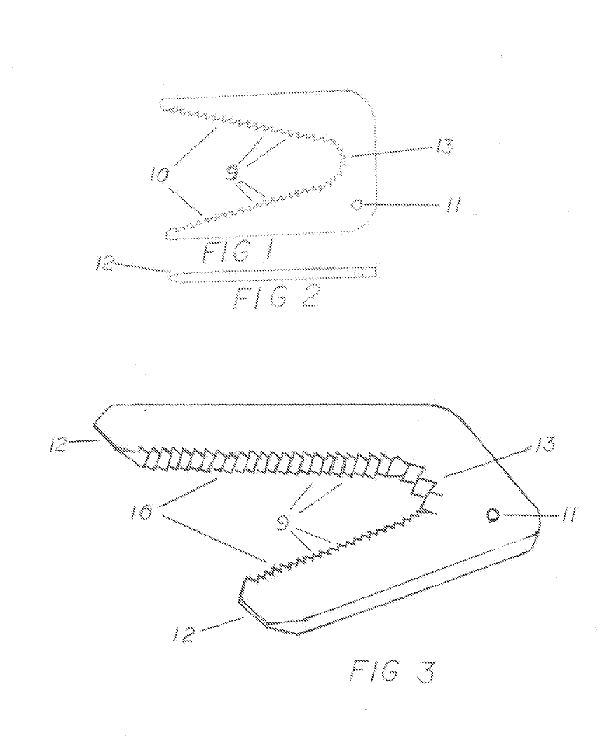

An embodiment of the cap remover is illustrated in FIG. 1. The body is one-piece construction of flatten material of thin thickness (0.120 inch, 3.048 mm) in the shape of a “V” with no moving parts. The “V” opening tapers ⅜ inch to 1¼ inches (9.525 mm to 31.750 mm). The opening is large enough to accommodate the various diameters of small crown bottle caps or other screw-off tops. The design allows for varying sizes and types of bottle caps whether metal or plastic. Miniature-to-medium sized bottle caps can be accommodated. The small compact size deems it readily accessible and portable.

FIG. 1 shows a perspective view of the capability to grip and hold. The “V” profile 9 construction includes faceted teeth 10 on the inside of the two arms of the “V” (FIGS. 1 and 3). The teeth are angled toward each other to better enhance the grip and securely hold onto the bottle cap or the divots in the cap. The teeth on one arm are slanted toward the end of the arm while teeth on the other arm slant toward the vertex.

FIGS. 1 and 3 display an eyelet hole 11 which enables attachment to a key chain, neck lanyard or a bracelet for easy immediate access and availability for use, or hung when stored. In FIGS. 2 and 3 the flat tips on the two arms of the “V” 12 are beveled for insertion to raise a can's lift tab edge of a ring-tab. The tips are also capable of puncturing plastic bags for opening and access. The teeth 10 or the vertex 13 can be pulled thru the bag to perforate further opening the plastic bag.

The shape and size is user friendly for the elderly or persons with physically restrictive grasping, gripping, and twisting issues. Additional leverage can be applied when the cap is engaged for twisting and removal.

This embodiment is contemplated to be made of aluminum, but alternative material of light weight and strength can be used. The light weight and small size enables it portable. The “V” profile, the facet teeth and eyelet attachment hole can be cut by laser, milling, machining, pressure stamping or other means known to the industry.

### Operation

### First Embodiment

The manner of operating the cap remover is very direct. Hold the embodiment in a flat position in the base of the fingers and the palm of the hand. The bottle cap is inserted into the jaws of the “V” opening 9 to a snug fit. Gentle pressure is applied by the index finger to press and hold the cap into the “V”, providing pressure against the gripping sidewall teeth 10 of the “V”. Increased pressure can be applied by the finger as necessary. An embodiment counter-clockwise twist is applied to loosen and remove the bottle cap from the securely held bottle. To open alternatively, the inserted cap can be held stationary and the bottle twisted clockwise for cap removal.

Caps are not damaged and can be reapplied. Caps are tightened and sealed by inverting and twisting the embodiment in a clockwise direction.

The inner facing edges of the “V” have angle faceted teeth 10 that slant to form an enhanced gripping and securing hold on a cap for loosing. They grip two sides of the cap simultaneously for added grip and leverage to loosen and remove the cap. The teeth grip and hold the bottle cap for twisting the cap to loosen and remove it.

Tighter gripping action results from stronger pressure into the vertex. The forefinger of the hand holding the embodiment is recommended to provide sufficient or additional pressure against the cap to secure and hold it in place at the vertex for loosening and opening.

The physical shape and the hand-held nature enable the user to readily twist off the bottle cap, and the design allows for addressing varying sizes and types of bottle caps whether metal or plastic.

The caps are not damaged which enables reuse and reapplying to the container.

The design enables caps to create a tight seal by turning it over for the angled teeth to grip the cap and twisting it clockwise on the container.

The light weight and small size enables it portable. It's readily attached on a key chain, neck lanyard or bracelet by using the eyelet hole 11, or carried in a pocket.

The shape and size is user friendly for the elderly or persons physically challenged to grasp, grip or twist bottle caps. These include arthritis, bursitis, broken or sprained wrists, arms, elbows and hands.

### Description

### Additional Embodiments

Additional embodiments are shown in FIGS. 2, and 3. Tab top cans and containers can be opened and also plastic bag containers. The outer tips 12 of the “V” triangle arms can lift metal tab rings on cans and plastic lift rings on cartons. The tips can puncture and tear open plastic bags.

### Operation

### Additional Embodiments

The flat surface on the outer end tips of the “V” triangle 12 has a tapered top and bottom surface. The tip is inserted under the ring pull tab on beverage cans and tab-top containers to lift the ring tab up. The raised tab enables finger grasp for completing the tab lift to open the container. Additionally, lift the tab slightly to insert a “V” arm tip thru the tab's ring opening and raise the tab upward and backward to complete opening the container without grasping by fingers.

The beveled arm tip ends 12 can open plastic bags, such as bags of ice, materials, or supplies packaged in heavier grade plastic bags. The teeth on the arms 10 or teeth at the vertex of the “V” 13 can be pulled to perforate opening the plastic bag.

### Advantages

Accordingly several advantages of one or more aspects are as follows: removal of screw off caps which current opener orifices are too large to fit and effectively remove. Damage and injury to fingernails, fingers and hands during container openings is avoided. Small bottle types include drinking water, beer, wine, miniature liquors, juice, soda, medications, spices, nail polish, lotions, cosmetics, and various solvents in home and industry. Business environment productivity can improve with speedier opening of the twist off caps on cans and bottles. Additional aspects can apply, including opening ring pull tabs on cans. Tab top cans and containers can be opened safely to avoid discomfort or injury to fingers and fingernails. Cartons containing liquids can be vent-punctured for even flow of contents. Plastic bags can beperforated for venting or opening for access to contents. Other advantage aspects can be apparent when considering the drawings and ensuing description.

This is useful and applicable in homes and industries. An industry such as airlines to open sealed drinking waters, miniature liquors and other tightened twist off caps; it will lift tabs on soda cans, and open the bags of catering ice. Salon personnel can open nail polish and solvents. Medical operations can open medicine containers and supply bottles. Workshops and industry can open solvents. It's a tool for home use to open bottles, ring tab-top cans and plastic bags.

### CONCLUSION, RAMIFICATIONS AND SCOPE

Accordingly this embodiment opens miniature and small sized twist-off bottle caps. It addresses the small units that cannot be opened by existing devices that have orifices too large to remove small caps. This opens small twist-off caps of various sizes and container types more quickly with minimum effort, increased leverage and without pain, discomfort or frustration.

It is contemplated that industries serving the public can apply this to the applicable beverage container types and other associated work activities such as opening plastic bags of materials and supplies. Similar functions in medical and salon practices are addressed which include opening miniature and small bottles containing screw off caps.

In addition to normal home use, the growing elderly population and physically impaired can benefit using the comfortable grip and leverage assistance provided in their daily livelihood.

Although the description above contains much specificities, these should not be construed as limiting the scope of the embodiments but merely providing illustrations of some of several embodiments. For example, a larger shape or differing dimensions can address other functions such as moving hot containers on grills or in ovens.

Thus the scope of the embodiments should be determined by the appended claims and their legal equivalents, rather than by the examples given.

I claim:

1. An apparatus for removing small twist-off bottle caps, comprising: a one-piece body, in side view being flattened and having thin thickness, and wherein an outer profile of said main body, when viewed from top or bottom, is wider in one direction and tapering, having a “V” opening therein, the inner edges of the “V” opening with faceted slanting teeth on the walls which taper toward each other and intersect within said main body.

2. The embodiment of claim 1, wherein said body is made of metal or rigid material, has no moving parts, is lightweight and portable.

3. The apparatus of claim 1, wherein is one-piece construction of flatten material of thin thickness in the shape of a “V”.

4. The apparatus of claim 1, wherein the inside area of the “V” tapers 31.750 mm (1¼ inches) at the outer opening to 9.525 mm (⅜ inch) at the vertex.

5. The apparatus of claim 1, wherein the two inner facing edges of the “V” have slanting faceted teeth configured to tightly hold the bottle cap for loosening and removal while the bottle is firmly held, and whereas the faceted slants on the inner arms of the “V” are angled in opposing directions for both arms to simultaneously secure the grip onto the bottle cap.

6. The apparatus of claim 1, wherein a cap can be tightened by inverting the embodiment, then inserting, gripping and turning the cap clockwise.

7. The apparatus of claim 1, wherein said main body provides additional hand held leverage for opening bottles and containers.

8. An apparatus for opening pull tabs on cans, comprising: a one-piece body, in side view being flattened and having thin thickness, and wherein an outer profile of said main body, when viewed from top or bottom, is wider in one direction, having a “V” opening therein, the edges of the “V” taper toward each other and intersect within said main body.

9. The apparatus of claim 8, wherein the two arms of the “V”, being a flat narrow surface with beveled tips that allow insertion under a ring pull tab on cans and other containers to open.

10. The apparatus of claim 8, wherein lifting the inserted embodiment to raise the pull tab up to enable grasping the lifted tab with fingers to complete opening the item.

11. An apparatus for perforating and opening plastic bags, comprising: a one-piece body, in side view being flattened and having thin thickness, and wherein an outer profile of said main body, when viewed from top or bottom, is wider in one direction, having a “V” opening therein, the edges of the “V” taper toward each other and intersect within said main body.

12. The apparatus of claim 11, wherein the two arms of the “V”, being a flat narrow surface with sharpened beveled tips that allow a forced piercing of a plastic bag for venting or draining the contents.

13. The apparatus of claim 11, wherein the two arms of the “V”, being a flat narrow surface with sharpened beveled tips that allow opening said plastic bag, and thereby tearing open the bag by inserting the vertex of the “V” into the opening and pulling the facet teeth thru the plastic to tear open.

14. The apparatus for claims 1, 8 and 11, wherein said main body further comprises a means for attaching said embodiment to a key ring.

15. The apparatus for claim 14, wherein said means for attaching comprises a hole through said main body.

16. The apparatus for claim 14, wherein said means for attaching comprises an eye attached to said main body.
